(19) United States
(12) Patent Application Publication
(10) Pub. No.: US 2015/0356498 A1
(43) Pub. Date: Dec. 10, 2015

(54) WIRELESSLY MANAGING PARKING

(71) Applicants: Andres E. Casanova, AVENTURA, FL (US); Carlos Damian Fernandez, Walnut, CA (US)

(72) Inventors: Andres E. Casanova, AVENTURA, FL (US); Carlos Damian Fernandez, Walnut, CA (US)

(21) Appl. No.: 14/733,113

(22) Filed: Jun. 8, 2015

Related U.S. Application Data
(60) Provisional application No. 62/008,912, filed on Jun. 6, 2014.

(51) Int. Cl. G06Q 10/08; G07B 15/06

(52) U.S. Cl. CPC G06Q 10/087; G07B 15/063

(57) ABSTRACT

Managing parking is carried out by associating an electronic tag with a vehicle, each tag configured to either receive, transmit, or both receive and transmit information at a low frequency using magnetic induction. A base station located in each parking space is likewise configured to either receive, transmit, or both receive and transmit information at a low frequency using magnetic induction. Either the tag or the base station will communicate identification information of both the tag and the base station to one or more servers, where parking can be managed. Communication with the server can be carried out in part using a publicly available radio frequency over a wide area network, such as one of the SigFox, LoRaWAN, or WEIGHTLESS protocols.

### CROSS REFERENCE TO RELATED APPLICATIONS

This application claims the benefit of related U.S. Patent Application No. 62/008,912, filed Jun. 6, 2014, entitled “System and Method Using Wireless In-Ground Sensors”, the contents of which are incorporated herein by reference in their entirety.

### FIELD OF THE DISCLOSURE

The disclosure relates to a system and method for tracking parking, and more particularly, to using low frequency transmission to wirelessly track and manage parking.

### BACKGROUND OF THE DISCLOSURE

Every trip in a roadway vehicle starts and end with a parking event, and finding a parking space has often become difficult. It is estimated that searching for parking causes 30% of traffic and congestion in downtown areas. The search for parking wastes time, money and gas, and adds to pollution and congestion. The lost time or inability to park can reduce potential revenue for businesses that depend on visitors finding parking.

Conventional parking meters are employed to collect revenue from eligible parking spaces. Parking meters permit drivers to rent each parking space for short periods, typically inserting money into the meter to purchase intervals of parking time, using a timer mechanism of the meter. When the purchased parking period has expired, the meter provide a visible signal enabling a parking enforcement officer patrolling the area to see at a glance that the parking space is occupied and to issue a parking ticket or take other action if parking has expired.

Multi-space meter machines enable a parking patron to pay with currency or a credit card to request parking permission, and typically provide a receipt which can be displayed with the car, or enable input of a license plate of the vehicle. In this manner, parking enforcement can view the receipt in the car, or check a companion computing system for the license plate, in order to validate that the vehicle's parking permit has not expired.

U.S. Patent Publication 2006/0212344 discloses a sensor for detecting the presence or absence of a vehicle, which can be a contact sensor, or a magneto sensor, which can be wired or which can use a loop wire and a sensing device.

China Patent CN103280121 describes a parking lot system which uses RFID card readers at entrances and exits of parking facilities, and ZigBee modules which transmit information from the RFID reads, and from parking place sensors. Parking sensors include pressure sensors and infrared obstacle avoidance sensors. China Patent CN103632425 describes a magnetic field emitting antenna that is used to sense the presence of a vehicle, and to activate a remote sensing key which emits a transmission including a code associated with the remote sensing key.

### SUMMARY OF THE DISCLOSURE

In an embodiment of the disclosure, a method for managing parking using one or more computers connected to an electronic communication network comprises associating an electronic tag with each of a plurality of vehicles, each tag configured to at least one of receive and transmit information at a first frequency; positioning an electronic base station proximate each of a plurality of parking spaces, each base configured to at least one of receive and transmit information at the first frequency; using one of the tag and base station to communicate identification information to the other of the tag and base station at the first frequency; communicating the received information, using the tag or base station which received the communicated information, to one or more servers; and processing the communicated information by the one or more servers to determine an extent of parking usage.

In variations thereof, the first frequency is in the LF range; the tag and base station communicate using magnetic induction; the base station is positioned proximate a driving surface of the one or more parking spaces; the base station is positioned below the driving surface of the one or more parking spaces; an electronic base station is positioned proximate a driving surface of each of the one or more parking spaces; and/or an electronic tag is positioned within a vehicle that is parked within one of the one or more parking spaces.

In further variations thereof, communicating to one or more servers is carried out using a wide area network of receivers using a publicly available radio frequency; and/or communicating to one or more servers is carried out by communicating with a local area network that is connected to the internet, the servers connected to the internet.

In another embodiment of the disclosure, a method for managing parking using one or more computers connected to an electronic communication network comprises associating an electronic tag with each of a plurality of vehicles, each tag configured to at least one of receive and transmit information using low frequency magnetic induction communication; positioning an electronic base station proximate each of a plurality of parking spaces, each base station configured to at least one of receive and transmit information at the first frequency; using one of the tag and base station to communicate identification information to the other of the tag and base station using low frequency magnetic induction communication; communicating the received information, using the tag or base station which received the communicated information, together with identification information of the tag or base station which received the communicated information, to one or more servers; and processing the communicated information by the one or more servers to determine an extent of parking usage.

In variations thereof, the base station is positioned proximate a driving surface of the parking space to be located beneath a vehicle when the vehicle is parked in the parking space; the base station is positioned below the driving surface of the one or more parking spaces; communicating to one or more servers is carried out using a wide area network of receivers using a publicly available radio frequency; communicating to one or more servers is carried out by communicating with a local area network that is connected to the internet, the servers connected to the internet; and/or communicating to one or more servers is carried out using at least one of the SIGFOX, LoRaWAN, and WEIGHTLESS standards.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings, in which:

FIG. 1 depicts a parking management system of the disclosure;

FIG. 2 depicts a transmitter/receiver base station in accordance;

FIG. 3 depicts a tag of the disclosure that is associated with a vehicle;

FIG. 4 depicts a series of adjacent parking spaces configured in accordance with the disclosure;

FIG. 5 depicts an illustration of a portion of a city showing available parking spaces, the illustration generated using a system of the disclosure;

FIG. 6 depicts detecting a change in magnetic field to sense an approaching vehicle, in accordance with the disclosure;

FIG. 7 depicts sensing a vehicle present using ultrasound, in accordance with the disclosure;

FIG. 8 depicts initiating low frequency magnetic induction communication with the vehicle, in accordance with the disclosure;

FIG. 9 depicts a tag associated with the vehicle communicating with a networked device, in accordance with the disclosure;

FIG. 10 depicts a tag communicating with a neighboring base station, in accordance with the disclosure;

FIG. 11 depicts a tag communication with a cellular network, in accordance with the disclosure.

FIG. 12 depicts a tag communicating using a low power wide area network specification employing a publicly available radio frequency, in accordance with the disclosure;

FIG. 13 depicts a tag communicating using radio frequency with a relay device connected to a WAN, in accordance with the disclosure;

FIG. 14 depicts a tag and a base station mutually communicating using radio frequency via a relay device, and further depicts a plurality of alternate vehicle detection systems, in accordance with the disclosure;

FIG. 15 depicts an embodiment of a tag of the disclosure;

FIG. 16 depicts an embodiment of a base station of the disclosure;

FIGS. 17-24 depict flow charts illustrating steps carried out by a processor in accordance with the disclosure, and more particularly:

FIG. 17 depicts a Learn Ambience Mode process;

FIG. 18 depicts an Optical WakeUp Mode process;

FIG. 19 depicts a Dark Mode process;

FIG. 20 depicts a Vehicle Detected Mode process;

FIG. 21 depicts a Vehicle Identified Mode process;

FIG. 22 depicts a No Tag Responded Mode process;

FIG. 23 depicts a Vehicle Parked Mode process;

FIG. 24 depicts a Parking Freed Mode process;

FIG. 25 depicts a beacon system of the disclosure; and

FIG. 26 depicts a computer system including one or more components which can be used to carry out the disclosure.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

The disclosure provides for parking permission and enforcement. A system of the disclosure includes a transmitting tag for attachment to the vehicle, and a micro-controller and sensors located on or under the ground within or adjacent to parking spaces. The tag serves as an identifier for parking related transactions, or other transaction, including for example payment for a car wash, gas station, drive through restaurant, or tollway.

In an embodiment of the disclosure, communication is established between a tag associated or forming part of the vehicle, and a base station under or near a parking space. The communication is accomplished using low frequency magnetic induction, which is able to pass through metal and liquids of the vehicle, and which has a very limited range, ensuring that a tag which responds to the base station is actually physically within the parking space associated with the base station, and not a tag in a vehicle in another space nearby.

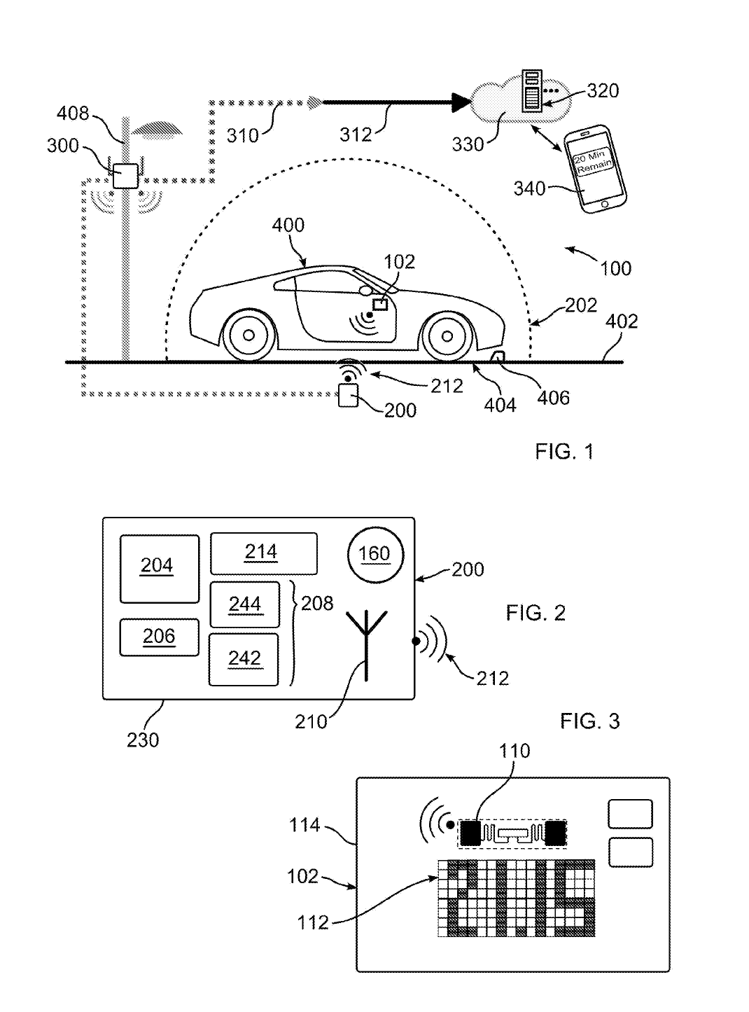

FIG. 1 depicts an embodiment of a virtual parking meter system 100 in accordance with the disclosure. A vehicle 400 is provided with a wireless communication device, or tag 102, by which the vehicle 400 is identified within system 100. Tag 102 includes a microprocessor, memory, battery or power coupling/connector, and antenna, and optionally one or more of a crystal, sensor, display, and one or more human interface devices (HID), for example buttons, joystick, touchpad, or other known or hereinafter developed HID, with or without haptic feedback. Each tag 102 is provided with a tag ID, which can be a unique serial number or other means of uniquely identifying itself. A database associated with system 100 can be used to correlate the tag 102 ID with a user account, vehicle, or both, as described further herein.

Tag 102 communicates with a remote receiver or transceiver, or base station 200, located outside the vehicle and associated with one or more parking areas. In an embodiment, the method of communication between base station 200 and tag 102 is via magnetic induction (magnetic field) or electromagnetic wave transmission, at any known frequency.

Magnetic induction is currently typically exploited at low frequency (LF), for example typically below 350 Khz, although magnetic induction can effectively be carried out at frequencies up to about 1.2 Mhz. A low frequency range for LF communication in accordance with the disclosure can be selected to be within a range of publicly available frequencies. Low frequency communication can be carried out, for example, using IEEE protocol 1902.1 (RuBee), or Qi, either of which, for example, can also be used for inductive power coupling to charge tag 102 and/or base station 200.

LF or lower frequencies have a limited ability to transmit data; however, system 100 can function with a very slow data rate between tag 102 and base station 200. The amount of data required to be transmitted for effective functioning per the disclosure is quite small; for example, in one embodiment, only the tag ID must be transmitted when tag 102 is within range of base station 200. Data relating to confirmation of parking permission, vehicle information, and expiration time can all be communicated using other means, described herein. Alternatively, even at low data transmission rates, such additional information can be transmitted to tag 102 in a timely manner.

Radio-Frequency ID (RFID) can alternatively used to communicate between tag 102 and base station 200, and between other components of system 100, at one or more frequencies between 200 KHz and 10 GHz. Typically, short range communication is carried out between 13.56 and 433 MHz. For communicating from a tag 102 through the frame or body of a vehicle to a base station 200 below or adjacent to the vehicle, however, there can be problems associated with RFID. These include difficulty transmitting through metal and water, and imprecision due to scattering and reflection. Moreover, an RFID signal can be received by a plurality of vehicles at the same time, and it can therefore be difficult to determine which tag 102 is closest to a particular base 200.

These problems are avoided using low frequency magnetic induction communication in accordance with disclosure. More particularly, LF communication has a very short range, eliminating the problem of a plurality of vehicle tags 102 responding. Further, LF communication can take place through metal of the vehicle, and through liquids of the vehicle, or water or snow which may be on the ground.

Communication between tag 102 and base station 200, and between other devices of the disclosure, can be carried out at higher frequencies, including for example using ISM (865-928 MHz), 802.11 (WiFi, typically 2450-5800, but currently up to 60 GHz), 802.16 (WiMax, 1.25 to 20 MHz), BLUETOOTH (2420-2483.5 MHz), LTE (700-2600 MHz). Other communication protocols which can be used include ANT UWB, Wireless USB, 6LoWPAN, DECT, HIPERLAN, 2G, 3G, 4G, GSM, IS-95, and EDGE.

It should be understood that communication between tag 102 and base station 200, or between tag 102 or base station 200 and other components of system 100, can be carried out with any known or hereinafter developed protocol, at any of a wide variety of frequencies, and is not limited to the examples provided herein.

In accordance with the disclosure, LF communication or communication by magnetic induction is advantageously used between tag 102 and base station 200 because communication by magnetic induction is not impaired by the presence of metal, for example a car frame or chassis, and water, for example a puddle, to the extent that communication using a predominantly electric field is. Magnetic induction is known to have a limited range of operation as compared to electric field, although the RuBee tag, for example, may operate through metal and water and ranges of between 1 and 30 meters, which is sufficient for implementation of system 100, as described herein. Accordingly, tag 102 can be positioned in a location easily viewed by an operator of vehicle 400, and can communicate with base station 200 when base station 200 is positioned at the level of the roadway, or beneath the roadway.

Alternatively, when higher frequency communication is used with a predominantly electric transmission component, for example typical RFID, tag 102 can be placed underneath vehicle 400, or away from any metal parts which might impede communication. Likewise, base station 200 can be located within a housing terminating at the level of the parking surface, and can include transmitter/receiver antennas that are not covered by transmission blocking materials. If a display is needed inside vehicle 400, a transmitting portion of tag 102 can be placed low within the vehicle or below the vehicle, and can communicate with a display or control unit located elsewhere within vehicle 400 by wired or wireless signal.

With further reference to FIG. 1, base station 200 is configured to generate a magnetic wave field, indicated to have a signal strength peripheral limit or boundary 202, although boundary 202 can have a different shape or dimension depending upon the type and strength of transmission of base station 200. As described herein, base station 200 is mounted upon or located within the ground or parking area support 402.

With reference to FIG. 2, base station 200 can include, cooperatively connected, a microcontroller; cpu, or processor 204; volatile and/or non-volatile storage 206; one or more batteries 160; various sensors 208, including, in some embodiments, a magnetic-field-sensor or magnetic field sensor 242, such as a magnetometer, and/or an ultrasonic transducer/transceiver device 244; and one or more antennas 210 configured to send and receive a signal 212 from a transmitter or transmitter/receiver 214, corresponding to the transmission frequency and type. In various embodiments, the foregoing base station 200 components can cooperate with, or form part of a millimeter-wave radar, and/or a communication board configured to implement any of the protocols mentioned herein, including for example ZigBee, WiFi, Bluetooth, Rubee, RFID and/or 3G/4G/LTE. In an embodiment, base station 200 includes a Bluetooth Low Energy transmitter 262 to serve as an indoor/outdoor proximity system, as further described herein. Base station 200 can include a weather resistant housing 230, which can be configured to have a low profile, and/or to be resistant to crushing by vehicles. Base station 200 can be powered by an onboard battery, which can be replaceable, or can be recharged by an inductive or plug-in charger or permanent power source. Base station 200 can alternatively be powered or charged by a transmitted wave signal.

With reference to FIG. 3, tag 102 can be used to communicate an identification number to base station 200, for example to enable a financial transaction or other accounting associated with a disposition of vehicle 400. The financial transaction can be accomplished using the internet, without requiring presentment of a token, cash, or credit card. While tag 102 can be configured to accept a payment using a near field communication (NFC) or radio frequency (RFID) payment method, including a key fob or touch to pay system, the identification number can be associated with an online account of a user or owner of the vehicle, and payment can carried out using the internet or other network topology, and a server computer (not shown). The server can obtain payment information associated with the tag ID, and can process payment using known or hereinafter developed methods.

It should be understood that two way communication between tag 102 and base station 200 is advantageous, at least in order to carry out acknowledgments, and to exchange information; however, the disclosure can be carried out where only one of the tag 102 and base station 200 transmits to the other, with respect to communication between tag 102 and base station 200. In this manner, the receiving device would be responsible for communicating the received information to a local or wide area network for further processing.

Tag 102 includes an antenna 110, not limited in configuration to the illustrative antenna shown in FIG. 3, which may be mounted inside or outside of a housing 114. An output device, such as a display 112, can be provided to communicate information pertaining to the parking transaction to a vehicle operator or user of system 100. Such information can include fees and prices, the tag ID, a parking transaction number, an ID number associated with base station 200 or other component of system 100, an account balance, a low-balance indicator, auto-refill information, and payment status. Buttons or other HID component 114 can cooperate with display 112 or other type of communication device to input information, for example to select information to be viewed, or to approve a transaction. In some embodiments, tag 102 is provided with a magnetic stripe reader, so that transient operators of vehicle 400 can pay for parking using a credit or debit card, without a requirement for previous registration of the vehicle operator as a user of a particular tag 102.

In an embodiment, system 100 tracks usage of parking spaces or other resource associated with a base station 200, in order to manage use of the resource. For example, parking may be provided without cost to users of tag 102, for example at a corporation or university, but it may be desired to know which parking spaces are in use, and which are available, in real time. In this sense, system 100 is not always used to process payments for use of parking spaces, but rather to account for an extent of use of spaces generally, or use of parking by individuals associated with a tag, specifically.

In an embodiment, a vehicle manager, vehicle operator, or user of system 100 causes a vehicle to be positioned or parked near to, adjacent, below, or above a stationing area, parking area, parking stall, or parking space 404. Such parking spaces 404 can be delineated from other spaces by lines, or may be demarcated in any other known way, and can be provided with a curb 406 or other alignment, limiting, or guiding device. A base station 200 is positioned with respect to parking space 404 so that communication with a tag 102 associated with a vehicle that is parked within space 404 is within range of communication. In the embodiment shown, base station 200 is positioned below or even with ground 402, although base station 200 can be mounted on a pole 408 or other structure at a height above ground, or above a height of the vehicle, for example on a ceiling or roof.

In one embodiment, when vehicle 400 is positioned with respect to space 404, sensors 208 detect the presence of vehicle 400. In one embodiment, sensors 208 include a magnetic field sensor that measures a variation in a magnetic field caused, for example, by a chassis of vehicle 400. The magnetic field sensor can use a perm-alloy magnetic field sensor, which includes a material having an electric resistance which varies based upon a magnetic field that passes through it, and which can be evaluated, for example by processor 204.

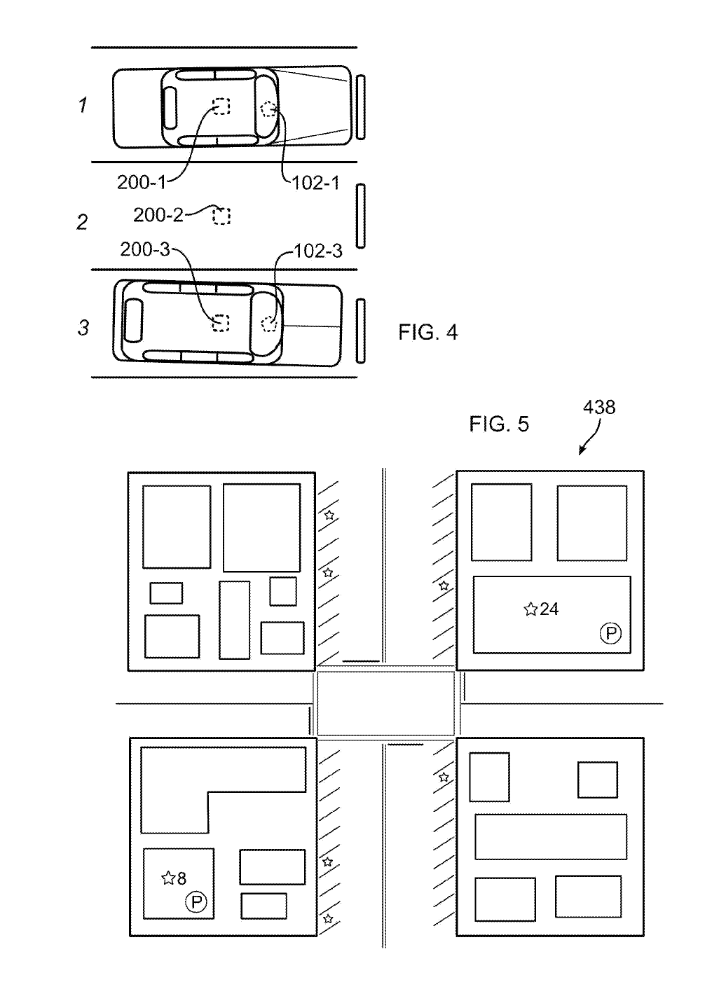

For example, as can be seen in FIG. 4, three parking spaces are designated as 1, 2, and 3, each having an associated base station 200-1, 200-2, and 200-3. Two vehicles 400-1 and 400-3 are parked in each of spaces 1 and 3, the vehicles including tags 102-1 and 102-3. In an embodiment, base station 200-1, 200-2, and 200-3 are each sufficiently sensitive to detect the presence of vehicles 400-1 and 400-3. To determine which vehicle is parked in corresponding space 404, a base station 200 can (a) issue a progressively weaker signal, wherein only the closest vehicle responds, wherein it is assumed that the responding vehicle is parked in the corresponding space 404 associated with the base station 200; (b) issue a low frequency magnetic wave of very limited range, for example less than or about the distance to a perimeter of the corresponding space 404, for which there should be only one tag 102 responding if one vehicle and tag 102 is within the perimeter of space 404; (c) issue a wave signal which is responded to by a plurality of tags 102, each tag responding with a measurement of the signal strength received, the base station 200 then correlating the tag 102 reporting the highest signal strength with the tag 102 within the corresponding space; (d) issue a signal receivable by a plurality of tags 102 within a limited range, and select the tag 102 which corresponds to the space 404 of the signaling base station 200, by comparing a GPS coordinate provided be each responding tag 102 which coordinates of the issuing base; (e) issue a signal receivable by a plurality of tags 102, and eliminate all tags 102 which report an existing association with a base station 200; (f) a combination of the foregoing. Base station 200-2 can avoid associating a tag 102 not within corresponding space 2, by using the foregoing methods, and by using some other means of detecting a vehicle, for example using a magnetic field sensor, radar, sonar, a magnetic or electric switch, an optical sensor, or a camera.

Alternatively, an operator of a vehicle associated with a tag 102 can report the vehicle's location, for example using smartphone 340, or a human interface of tag 102, and the location can be associated with the closest base station 200, or any base station 200 which is capable of communication with the corresponding tag 102. In an embodiment, a single base station 200 can communicate with a plurality of vehicles, using the foregoing methods to detect a location of the vehicle. In another embodiment, the exact space 404 of the vehicle is not needed and may remain undetermined, where the rules of the system 100 enable satisfactory operation if it is simply known that the vehicle is within range of any base station 200.

In another embodiment, one or both of base station 200 and tag 102 transmit a poling signal periodically, which is detected by the other. Other known or hereinafter developed devices can be used to detect the presence or absence of vehicle 400, including for example an ultrasonic, infrared, audio, or video signal, or an electric switch.

A predetermined time period after vehicle 400 is parked, for example 20 seconds or any other time period which would usually indicate an intent to remain in space 404, tag 102 can be processed by system 100. For example, where tag 102 includes a passive receiver, base station 200 can emit a signal which causes a corresponding response from tag 102. In another embodiment, for example in a low frequency system, transmitter/receiver 214 is a magnetic wave transceiver, and is activated by a signal from base station 200. In one embodiment, this activation signal corresponds to a predetermined high-security protocol which includes data encryption, such as the IEEE 1902.1 protocol. In response, tag 102 transmits the tag ID, and may transmit other data useful for parking transaction, including for example its power level state.

In one embodiment, base station 200 processor 204 executes a set of software instructions which cause transmitter 214 to emit various broadcast intensities in order to limit and expand the number of responding tags 102, to thereby determine a proximity of the various tags 102 responding at each intensity, and to thereby determine a closest vehicle 400. Once the closest vehicle is determined, responses associated with other tag IDs can be ignored, if intended.

Once a desired tag is identified, this information can be transmitted from base station 200 to a transaction server, by one or more routes. As shown in FIG. 1, after successful obtaining information pertaining to tag 102 and its associated vehicle 400 or operator, base station 200 can communicate the relevant information to a relay 300, which retransmits the information to a wider area network, including for example the internet or a cell network. A dashed line 302 indicates communication between base station 200 and relay 300, and can be either a wired or wireless pathway, using any known or hereinafter developed communication protocol, including any of the wireless protocols mentioned herein, or a wired protocol such as an Ethernet lan or serial connection, for example.

Relay 300 can have the form of computer server, or can be a simple transceiver. If wireless transmission over a substantial distance is desired, relay 300 can be attached to tall pole, for example a light pole 408. For example, if retransmitting parking data wirelessly, relay 300 can include a transceiver 314 (not shown) which can participate in network 310, for example a WiFi mesh network or 3G or LTE cellular network. Relay 300 can alternatively or additionally be connected to the internet, either directly to an ISP, or through a router, for example. Relay 300 can be connected to a power source, for example a citywide electric grid or solar cell, and can include a backup rechargeable power source, such as a battery. Relay 300 can transmit to other relays 300, of similar or divergent architecture. Relay 300 can include a processor, memory, data storage, software, transmitter, receiver, power source, timer, and other components (not shown) as needed to carry out the functionality described herein. In one embodiment, relay 300 is a wireless router.

Ultimately, information obtained from tag 102 can be transmitted via relay 300 to the internet or other wide area network 312, and to a computing cloud 330, where the data may be processed by one or more computer servers 320. Servers 320 can include one or more databases which store information pertaining to vehicle owners or operators, tags, vehicles, payment methods, payment history, membership information, parking plan rules, parking vendors, parking areas, parking rates, available parking, physical parking dimensions and limits, and other information pertaining to a parking program using system 100. This information can be used to generate information which is useful to a vehicle 400 operator before, during, and after parking, some or all of which can be displayed by tag 102, or may be transmitted to a computer device 340 of the operator, using cloud 330, and internet 312 and/or a cellular network, for example. Some of servers 320 can form an integrated part of system 100 of the disclosure, and other servers 320 can be provided and/or operated by third parties, providing information and services to system 100 that are freely available or available on a fee basis.

Computing device 340 is illustrated as a smartphone in FIG. 1, however it may have the form of any computing device known, including another server, desktop, laptop, tablet, watch, or in-vehicle computing system. A software application or app 322 executes on a processor of computing device 340, the application configured for displaying information pertaining to the current parking parameters, including time remaining, location of the vehicle, instructions for adding time, and/or an interface for entering or changing membership, checking an account balance, replenishing an account balance, entering or changing payment method, and other current and past parking and payment information.

App 322 can further provide information pertaining to a location of available parking spots, for example superimposed upon a map, or entered into a drive mapping interface. Additionally, app 322 can receive targeted ads or notifications relevant to a location of tag 102, or a current location of a smartphone 340 associated with tag 102. Such ads can include offers for free parking using system 100 in exchange for purchasing from one or more vendors, and particularly vendors within an area adjacent to tag 102 or smartphone 340.

In an example parking transaction, base station 200 associates with a particular tag 102 as described above, and an account associated with tag 102 is identified. If the account is inactive, parking is not authorized until the account is reactivated. In an embodiment, workers for a parking authority, for example a private or governmental organization, are able to access servers 320 using an application on a computing device 340 which can be different than the application available to users. For example, the parking authority may receive an indication of a list of license plate numbers which having currently active parking permission for a space 404 or other area. Alternatively, the parking authority can be provided with a portable base 250 which can communicate with one or more tags 102 of parked vehicles, and/or one or more bases 200, and which can indicate, for example on a display, or with a colored light, if a parked vehicle currently has parking permission or not, as communicated by the tag 102 or base station 200. In this embodiment, the tag 102 or base station 200 received information regarding whether the parking session was authorized or not using any of the communication networks and protocols described herein.

If the tag and user account is active, the user can indicate a desire to park in a particular space 404 or area for a particular length of time, and/or for a variable length of time, according to how software of system 100 is configured. The operator can indicate this using an interface of tag 102, or using computing device 340. Software of system 100, executing on any computing device of system 100, including computing device 340, server 320, tag 102, base station 200, or relay 300, can ensure that the tag 102 that is registered or associated with a particular base station 200 belongs to a particular account that the operator is attempting to use when requesting parking authority using computing device 340. Once this authentication is complete, and the requested permission has been granted, a parking timer associated with any computing device of system 100 can commence.

A confirmation of acceptance of parking permission and the start of the timer is communicated to the user by one or more of tag 102 and computing device 340. As examples, a green light can be indicated on tag 100, or alternatively, a push notification or SMS message can be sent to a designated computing device 340 of the user of system 100 to communicate the state of parking permission, or other information, including the price of the specific parking permission requested. This notification information can assist the user in deciding when to vacate the space, for example within a predetermined time frame, in order to avoid charges.

System 100 can be configured to allow a fixed amount of time for parking, which in an embodiment can be extended. Alternatively, a time based fee can be charged for the time in which vehicle 400 is within space 404, as determined by communication between tag 102 and base station 200. System 100 can be programmed to change a fee charged after a predetermined time passes, whether for fixed time, fixed time with extension, or time based parking rules. This may be desirable, for example, where a parking authority designates a maximum parking time. In various embodiments, parking rates increase, a parking surcharge is applied, authorities are notified to remove a vehicle, or a combination of the foregoing. Charges stop when it is determined that vehicle 400 is no longer within a designated parking area, as determined by the original tag 102 and base station 200 with which parking was established, or as determined by any other means, including the user or other people associated with the parking area, or as determined by other bases 200 communicating with tag 102. Notification of a termination of the parking session can be sent to tag 102 for display, for example text on a screen, or a red light, or can be indicated using computing device 340, for example a “parking end” push or SMS notification, which can also indicate the duration and cost for the parking permission granted.

In a further embodiment of the disclosure, available parking spaces in the vicinity of vehicle 400, or near the destination of vehicle 400, can be communicated to the user, for example by displaying such information on computing device 340. With reference to FIG. 5, a portion of a city 438 is diagrammatically represented, for example upon a display of device 340, upon a display of tag 102, or upon a display system associated with vehicle 400, as communicated to the vehicle from base station 200, tag 102, or the internet, for example. The displayed portion can indicate available parking areas, and can further indicate, in this example with a star, spaces 404 which are either free, or have been taken. Public parking or other available parking lots or facilities can be designated, in this example with the letter ‘P’ in a circle, and can further designate a total number of spaces remaining, if designating individual spaces is impractical. Data regarding the location and number of spaces can be provided by all spaces 404 which are monitored by one or more bases 200, which advantageously is all spaces within a given geographic area. One or more central servers 320 can compile available space 404 data from all bases 200, and can combine the data with maps or diagrams in storage, or which are available from other databases. Alternatively, server 320 can calculate coordinate locations for all free spaces 404, or bases 200 can provide such coordinate locations, and mapping can be carried out by devices 340, or a processor of vehicle 400. For example, available spaces can be imported or received by computing device 340 or by a navigation system of vehicle 400, and can be presented in the same manner as other mapped sites within the system.

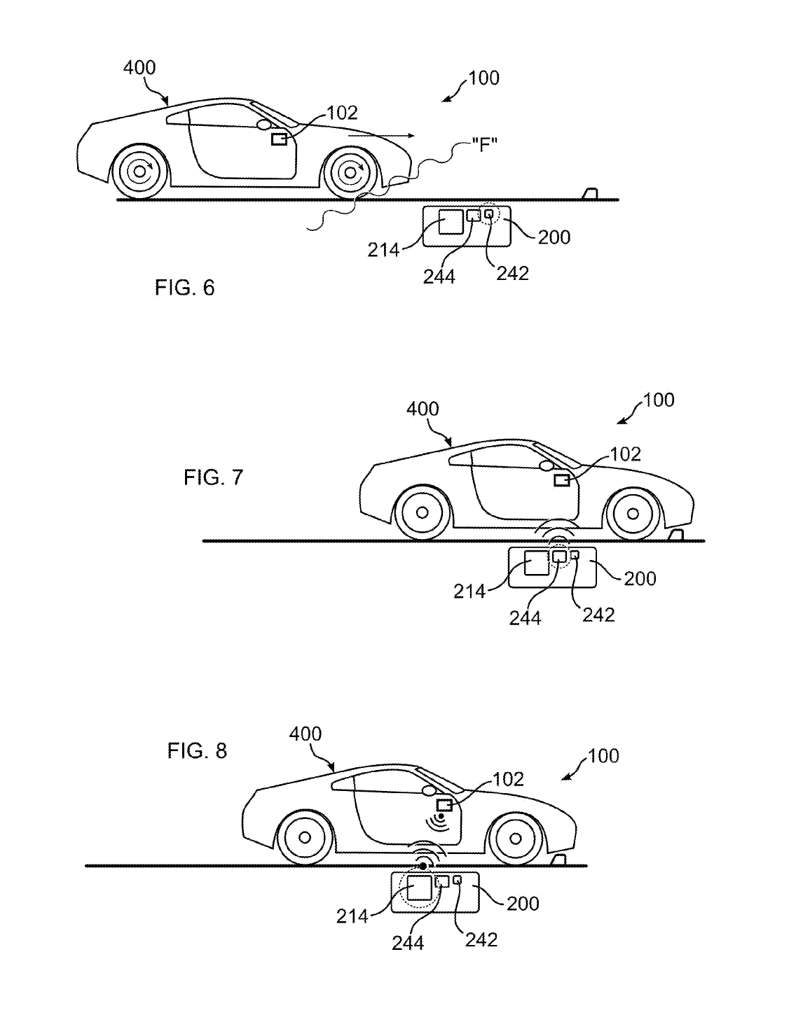

With reference to FIGS. 6-9, in an alternative embodiment of the disclosure, base station 200 is provided with a magnetic field sensor or magnetic sensor 242 which detects small changes in an ambient magnetic field, while consuming very low amounts of energy. A device for measuring changes in magnetic field, in an embodiment a magnetic sensor 242, may poll or sample the ambient magnetic field at intervals, for example seconds or fractions of a second. As a vehicle approaches magnetic sensor 242, a change in magnetic field is detected, which is communicated by magnetic sensor 242 to processor 204 to indicate a possibility that a vehicle is approaching base station 200. Magnetic sensor 242 is encircled by a broken line to indicate it is active in the illustrated step. As with other drawings herein, the elements within the figures are not drawn to scale.

In an embodiment, a baseline measurement of the Earth's magnetic field, or other ambient magnetic field, is measured by one or more magnetic sensors 242 in the absence of a vehicle in a space monitored by base station 200. Magnetic sensor 242 can signal to processor 204 a change in magnetic field (indicated diagrammatically by wavy line “F”) relative to the baseline, which can be indicative of the presence of a vehicle.

In an embodiment, magnetic sensor 242 periodically electrically communicates new magnetic field measurement values to processor 204. These magnetic field values can be processed by processor 204, and may be stored in storage 206. These periodic, or polled results are analyzed by processor 204 to determine if the relative changes in magnetic field correspond to the approach and/or presence of a vehicle. Accordingly, in this embodiment, magnetic sensor 242 must provide a plurality of measurements within a time period corresponding to a typical approach.

More particularly, in one embodiment, processor 204 is provided with data corresponding to magnetic field measurements at various stages of approach for various vehicles, and/or various stationary positions of various vehicles. These can be compared with data from the magnetic sensor to more accurately determine if the measured magnetic profile corresponds to a vehicle or motorcycle, as compared to one or more pedestrians or other object.

The magnetic sensor derived data can be sufficient for software executed by processor 204 to determine that a vehicle is probably present, after which an attempt can be made to communicate with tag 102 using LF communication, as described herein. However, LF communication can use substantial amounts of electrical energy, and base station 200 may be operating using only batteries. Accordingly, in such embodiments, it may be particularly advantageous to minimize the use of LF transmissions. This can be accomplished by using other more energy efficient means of ensuring that a vehicle is present within parking space 404.

Accordingly, in a further embodiment, and with reference to FIG. 7, an acoustic transmitter/receiver device 244, for example an ultrasonic (US) transceiver, can be associated with base station 200, and can be used to test further if a vehicle is present in parking space 404. US device 440 can obtain further data regarding the configuration of an object proximate base station 200 using substantially less energy than would be required by two way communication using LS transmitter/receiver 214 as described herein. More particularly, US waves reflect from a vehicle in a distinct manner, and travel through different materials at different speeds. Processor 204 can be provided with data corresponding to expected results received from transmission of US waves into a variety of vehicles which may be parked within space 404. These profiles can be used alone, or can be compared with signals received by pedestrians, bicyclists, or other objects, to determine if parking of a vehicle has occurred.

US device 244 can be used in place of a magnetic sensor, for measuring an approaching vehicle, or for measuring a stationary vehicle. However, energy consumption would typically be higher than for magnetic sensor 242. By using the most efficient sensor at each stage, the lowest amount of energy can be consumed overall. Ultimately, after confirmation of a vehicle by US device 244, it may reasonably be concluded by processor 204 that LS transmission can begin, in order to attempt communication with tag 102, as illustrated in FIG. 8.

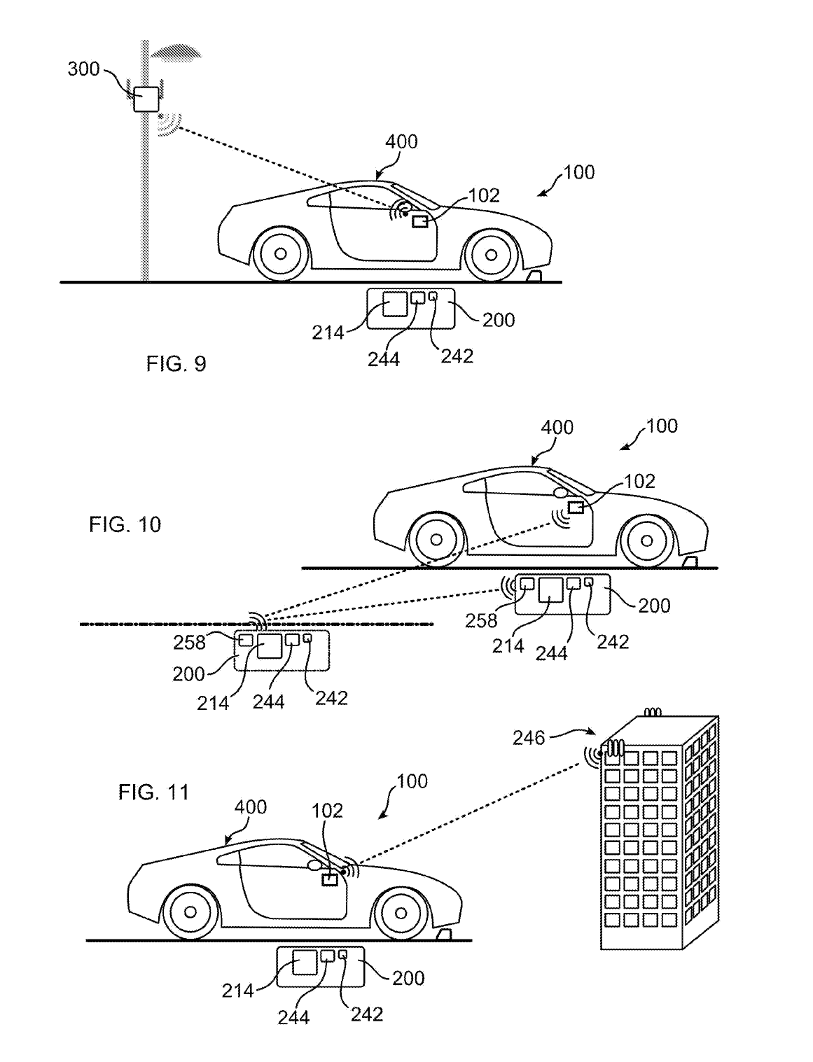

With reference to FIGS. 9-12, it may be seen that in some circumstances tag 102 may fail to communicate with base station 200. For example, base station 200 does not receive a reply from tag 102 within a predetermined time period, or tag 102 does not receive an acknowledgement from base station 200. This can be caused by a low battery within non-passive tags 102, a disadvantageous positioning of antenna 110, an excessive distance between tag 102 and base station 200, a component malfunction, or a communication failure by base station 200 for any of the foregoing reasons. In this event, in accordance with the disclosure, tag 102 can communicate with a substitute device other than the instance of base station 200 associated with the current parking space (the current base station 200). This can include a WiFi or Bluetooth device nearby (FIG. 9), a base station 200 in a nearby parking space (FIG. 10), or a cellular network device 246 (FIG. 11).

Similarly, base station 200 may be unable to communicate with a tag 102, the internet, or a local network connected to the internet. In such an event, if a nearby tag 102 or base station 200 has a working connection to the internet, base station 200 can request that information be forwarded by such nearby device. In accordance with the disclosure, tags 102, bases 200, relays 300, and other communication enabled devices of the disclosure provide alternative pathways for each other to thereby overcome failures or environmental obstacles in communicating to each other or to the internet and server 320. Such communication is limited only be the compatibility between the various communication methods enabled within each respective device. Moreover, should a means of communicating to the internet fail for one device, and another device uses an alternative pathway, communication can be rerouted through another device to regain connectivity. Various alternative pathways can include any WAN access method disclosed herein, including for example SIGFOX, LoRaWAN, WEIGHTLESS, CDMA, GSM, LTE, or a connection to a local ISP via a phone line, cable, or satellite dish. Either base station 200 or tag 102 can use an alternative pathway to communicate its hardware status or problem, or a power level state, for example where there is insufficient power to communicate using another mode.

In each case, tag 102 has received a communication from the current base station 200, and has obtained information pertaining to the current parking space. Accordingly, tag 102 can communicate its own identification, which is associated with the current vehicle or tag owner, and identification associated with the current base station 200, through the substitute device, to a network and to server 320, whereupon processing can occur as described elsewhere herein.

In FIG. 9, tag 102 communicates with a relay 300 using any known wireless means, including for example WiFi, Bluetooth, IR, UF, FSR, or other known means. As the power in tag 102 is limited, it is advantageous to use a device with a low energy consumption, which is facilitated by the low bandwidth requirements of the communication. Accordingly, a communication protocol such as ZIGBEE or Near-Field Magnetic Induction Communications (NFMIC) can be used. For example, a ZigBee transceiver 266 can be provided within relay 300, and a ZigBee transmitter can also be used to communicate from relay 300 to another device which is connected to the internet. Alternatively, relay 300 may itself be connected to the internet, or can connect to another device which is connected to the internet using any known means, including a wired or wireless connection.

In FIG. 10, tag 102 which is unable to communicate with current base station 200 can communicate with another nearby base station 200, as depicted in FIG. 10, an alternative to LF communication can be used, as a signal can be broadcast from tag 102 to a plurality of bases 200 nearby, and any base station 200 that is not obstructed by metal or water can respond. Accordingly, such other communication methods can include any method disclosed herein, including WiFi, Bluetooth, IR, US, or radio frequency such as UHF, FSR, or other available frequency.

In a variation thereof, a responding nearby base station 200 can communicate with the current base station 200, for example using LF communication, as depicted. Other means of communication between bases 200 can be carried out depending upon which alternative means of communication are provided within bases 200. For example, bases can be adapted to use ultrasound if configured with US sensors, or IR or other optical sensor if configured therewith, as described elsewhere herein. Alternatively, bases 200 can be equipped with any other wired or wireless communication method described herein, and can communicate amongst each other using such other methods.

In a variation, a first communication protocol is used by one base station 200 or tag 102 to request that another base station 200 or tag 102 switch to an alternative communication method for further communication. In a yet further alternative, neighboring tags 102 can relay information to each other for forwarding to a local network, the internet, or to a particular base station 200, using, for example ZigBee or other low power protocol which supports relaying.

In FIG. 11, it may be seen that tag 102 can communicate with a cellular network 246. As such, tag 102 would require significant transmitting power, and a SIM card or other device which supports available cellular network requirements. In such embodiments, and in any other embodiment of the disclosure, tag 102 can be connected or connectable to a power source, or can be charged using inductive charging, or can include a replaceable battery which can be rechargeable. In an embodiment, base station 200 can use low frequency magnetic induction charging to recharge a tag 102 or a neighboring base station 200.

In a further embodiment of the disclosure, tag 102 communicates with an onboard WAN communication system, such as an in-vehicle WiFi router, or a proprietary system, such as the ONSTAR or MBRACE communication system, to communicate information to the internet. It should further be understood that one or all components of tag 102 described herein can be integrated into the design of a vehicle. More particularly, one or more electronic components of tag 102 can be integrated into electronic components of the vehicle, for example within a CPU board of the vehicle, and some or all processing can be carried out by a processor of the vehicle. Similarly, other antenna and components of the vehicle can be used to carry out one or more forms of communication. Accordingly, the term ‘tag’ herein refers to the elements and attributes of tag 102 described herein, however implemented within a vehicle, and does not necessarily imply a discrete moveable tag-like object, although that is one embodiment.

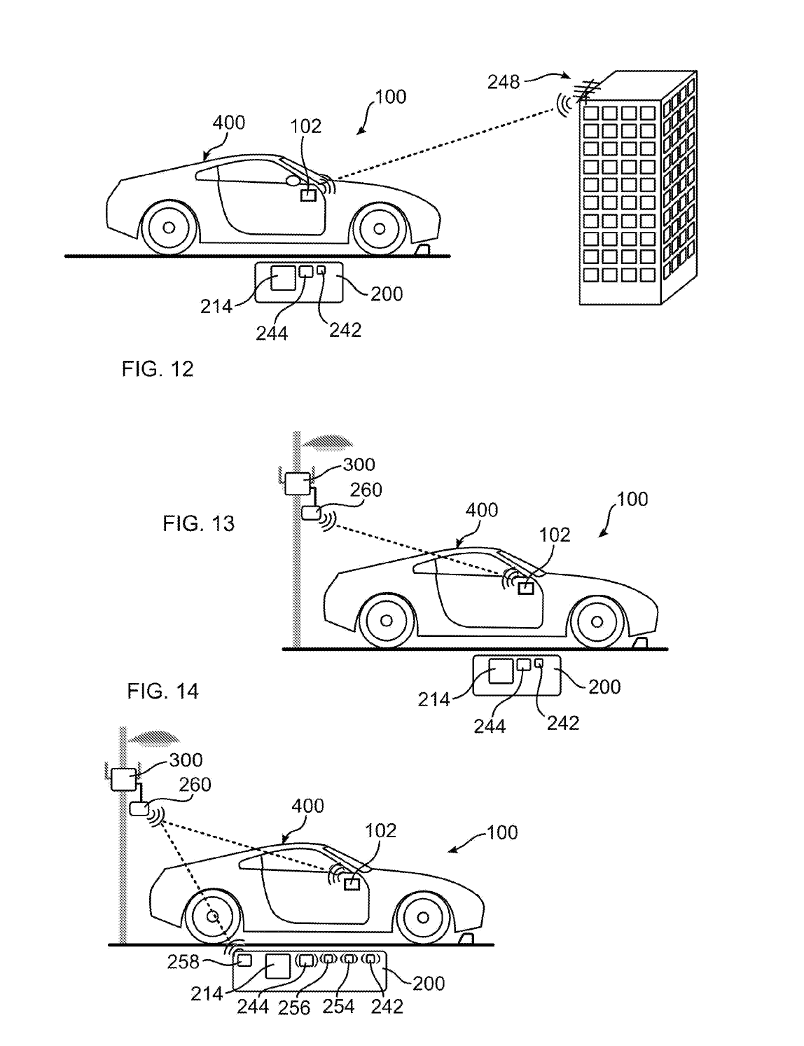

With reference to FIG. 12, tag 102 can include a network communication device 258 of limited bandwidth capability and high efficiency, as the quantity of information to be transmitted is very small. Specifically, the information required to be transmitted can be as small as an identification of the parking space, an identification of the tag, and arrival and departure time information, and optionally a power level of tag 102. As such, a low power wide area network 248 can be used, such as is provided by SIGFOX, together with SIGFOX enabled devices 264. This network, in particular, uses the 915 MHz ISM band in the U.S., and 868 MHz in Europe. Such devices are low cost compared to GSM or 3G style devices, and use less power. Other publicly available radio frequency bands can be used, for example including 900 MHz and 2.4 GHz. In this embodiment, tag 102 communicates to a nearby receiver 252, which in turn is connected to the internet or other WAN in some other manner, for example through relay 300, which may be a wired switch or WiFi transceiver, for example.

The SIGFOX communication protocol can include increased costs for higher traffic volumes. Accordingly, use of such systems can be limited to situations where none of the other methods disclosed herein for communicating parking and related information are available. In accordance with the disclosure, base station 200 and tag 102 are provided with software which chooses among the various alternative communication methods described herein, advantageously selecting the lowest energy consuming method and/or lowest cost method, to progressively higher energy and/or higher cost methods. As alternatives to SIGFOX, either a LoRaWAN (of SEMTECH, Camarillo, Calif.) enabled device 268, or a device 270 based upon the WEIGHTLESS standards (Weightless SIG, www.weightless.org), all of which are low power wide area network specifications, can be used, or other low power alternative currently known or hereinafter developed.

FIG. 13 illustrates tag 102 using one or more of the foregoing communication methods, or other communication method described herein, including a publicly available bandwith, such as certain UHF frequencies, to communicate with a transceiver relay device 260 which is connected to a WAN or to another relay device 300 connected to the WAN. This alternative pathway can provide a means of acknowledging or communicating back to base station 200, or otherwise communicating parking, battery state, or other information. Communication methods which can communicate over a wide area, for example a citywide area, such as a SIGFOX device, have an advantage in that information can be communicated to server 320 if internet service associated with parking space 400 is interrupted. In certain configurations of the disclosure, such devices are only used when internet service used in association with parking space 404 is not available, due to cost considerations.

More particularly, in an embodiment, each base station 200 can be provided with a ZigBee transmitter and receiver. The receiver transmits in the UHF spectrum, for example 900 MHz, and can be configured to only become active when the base station 200 receives a ‘wake up’ signal from processor 204, for example when data was ready to be transmitted to the WAN. This would result in significant power savings over time, particularly if UHF is only used sparingly, for example in cases of a cloud outage. This backup system can be configured whereby a base station 200 can wake up a neighbor base station 200 via a low-frequency magnetic field sequence signature, and thereafter a message can be relayed from base station to base station, until it reaches a base station equipped with an internet gateway, such as a base station 200 with a SIM card to connect to a GSM (for example AT&T) or CDMA (for example VERIZON) network, or a hard-wired Ethernet connection.

In FIG. 14, a further alternative for detecting the presence of a vehicle is illustrated. An optical sensor 254, for example a CdS Photocell or other inexpensive photocell, which requires extremely low amounts of standby energy, for example less than magnetic sensor 242 that is polling, and can continuously detect a change in ambient lumens of a predetermined extent. This can occur when vehicle 400 passes over optical sensor 254, blocking an amount of light from reaching base station 200 and optical sensor 254. During the evening, another method, for example a somewhat less efficient method, can be used to detect the presence or absence of a vehicle, for example acoustic sensor 244, as described elsewhere herein. Nighttime can be determined by comparing a local time with daylight hour tables, or by any other means. Alternatively, a light of a predetermined frequency and strength can be directed to optical sensor 254 from a position above parking space 404 and base station 200, which light source will not reach sensor 254 when a vehicle is present.

Additionally, or alternatively an infrared (IR) sensor 256 can be used to detect engine, brake, battery, or exhaust temperature of a vehicle entering parking space 200. The IR sensor can consume less energy during standby than magnetic sensor 242 that is polling. As with optical sensor 254, magnetic sensor 242 is turned on to detect the presence of ferromagnetic material of the vehicle when a vehicle within parking space 404 is detected. If a vehicle is present, magnetic sensor 242 may obtain further measurements for greater confirmation, or LF communication can begin if certainty reaches a predetermined threshold. In FIG. 14, various sensors are depicted in parentheses, to indicate that various combinations of sensors can be incorporated into base station 200, selected based on available energy, the cost to recharge or replace batteries within base station 200, a need to distinguish various types of traffic which may pass near or over parking space 404 and a vehicle parked within space 404, and other cost or design considerations. Multiple sensors can be used together or sequentially to obtain a desired level of certainty regarding a parked vehicle.

As further illustrated in FIG. 14, tag 102 and/or base station 200 can communicate information to a relay device 300 and to the internet, or can communicate information between each other via like type of transceiver 260 and/or relay 300, or by separate transceivers 260/relays 300 and a LAN or WAN.

In this manner, system 100 can be configured whereby base station 200 is not configured to communicate with either a local network or a wide area network, but rather is only configured to communicate with a tag in a parked vehicle within parking space 404 using low frequency magnetic induction, and need only transmit an ID value associated with the base station. As such, in one embodiment thereof, base station 200 does not include a receiver. Accordingly, processing and communication with a local and/or wide area network, as described herein in relation to base 200 or tag 102, is carried out entirely by tag 102. More specifically, tag 102 will communicate the base ID, the tag ID, and the time of parking and departure to the local network. A departure, or park-out event can be determined by a failure of base 200 to respond to polling by tag 102 using LF communication, for example, or by any other means by which tag 102 can determine it has moved since the last park-in event, including Bluetooth or GPS information obtained from smartphone 340, for example.

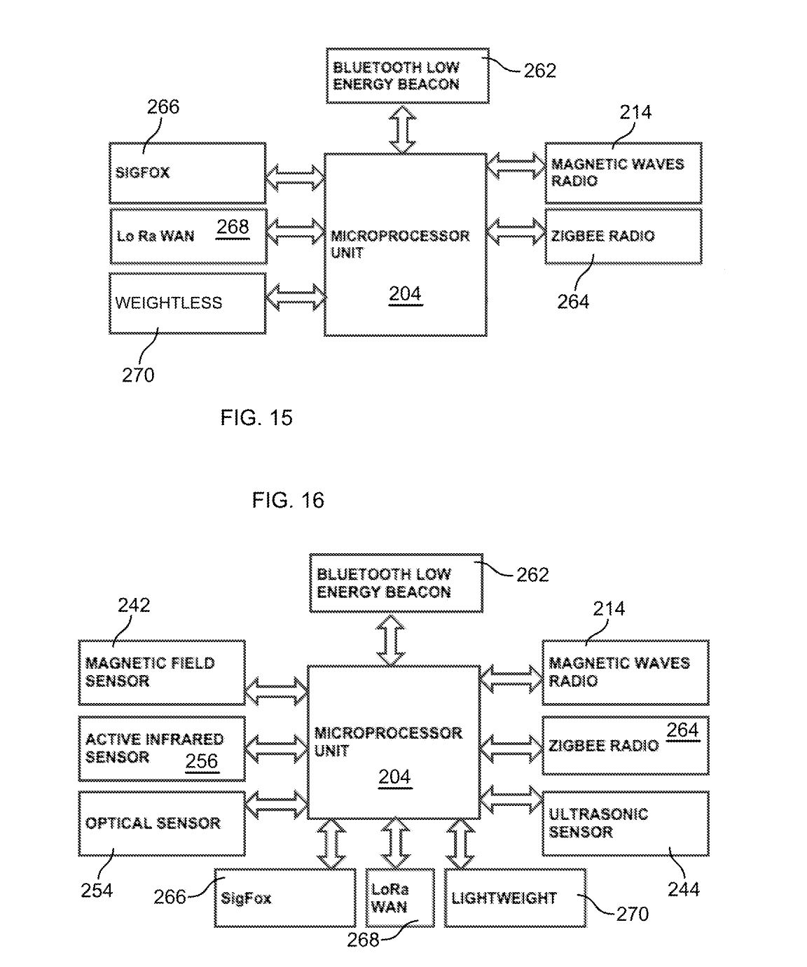

FIGS. 15 and 16 illustrate one possible configuration of a tag 102 and base station 200, respectively, in which a plurality of low bandwidth highly efficient devices 258 are communicatively connected to a processor 204. FIG. 16 further illustrates a magnetic field sensor 242, optical sensor 254, acoustic sensor 244, and IR sensor 256 connected in communication with a processor 204.

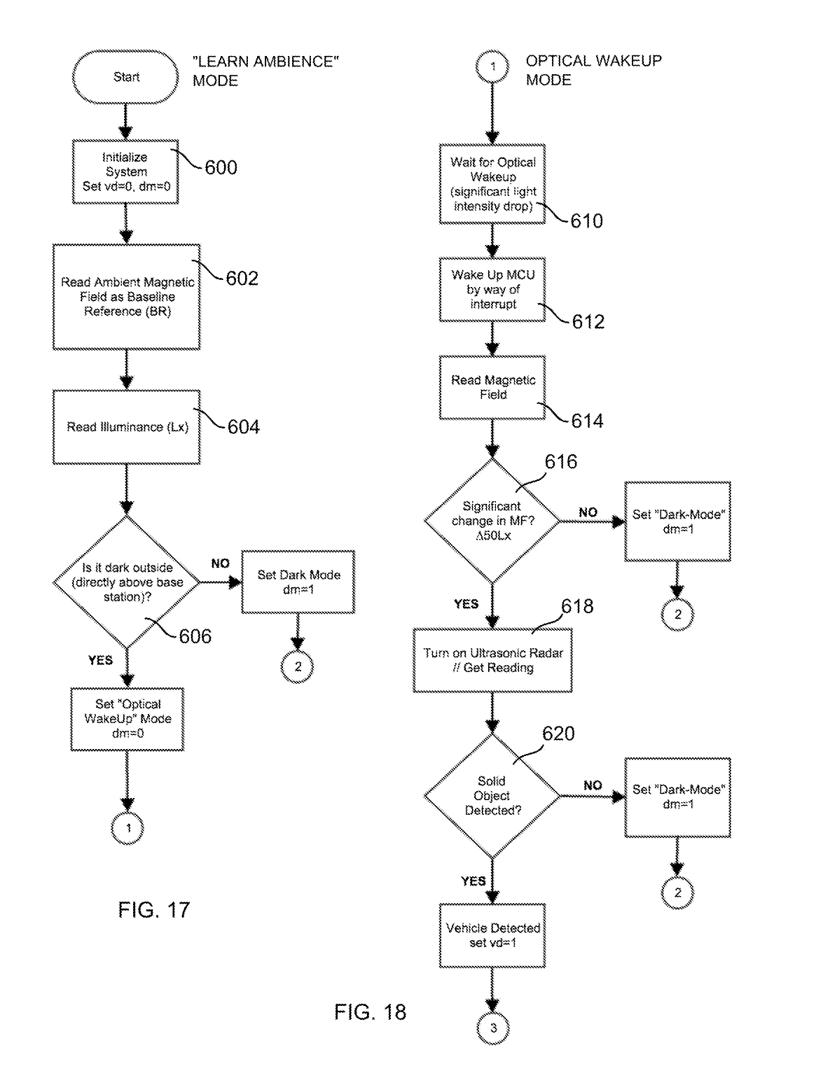

With reference to FIGS. 17-24, a flow chart for operation of one embodiment of the disclosure is provided. In step 600, in a ‘Learn Ambience’ Mode, processor 204 initializes a dark mode or dm=0 to indicate that it is not a nighttime or non-illuminated environment, and a vehicle detected mode or vd=0 to indicate that no vehicle is present. In step 602, a baseline magnetic field reference is obtained by magnetic sensor 242. In step 604, optical sensor 254 obtains a current light level, or illuminance Lx. In step 606, it is determined using sensor 254 if it is dark at a location above base station 200. If it is, dm is set to 1, and processing continues at entry point 2; otherwise, dm is set to 0, and an ‘optical wakeup’ mode is set, whereby processing continues at entry point 1.

In FIG. 18, in an Optical Wakeup Mode, processing begins at entry point 1, and in step 610, optical sensor 254 monitors ambient light for a predetermined drop in light intensity. When such a drop in intensity takes place, processing continues at step 612, whereupon a magnetic control unit including magnetic sensor 242 begins taking one or more readings of an ambient magnetic field, as described herein. At step 616, if the change in magnetic field is greater than a predetermined amount, or a magnetic profile indicates a parking vehicle, processing continues at step 618, where a circuit including acoustic US sensor 244 is activated, and acoustic readings are taken; otherwise, dm is set to 1 and processing continues at entry point 2. In step 620, processor determines, based upon data from acoustic sensor 244, whether a solid object, and more particularly if a vehicle is present. If not, dm is set to 1 and processing continues at entry point 2; otherwise, a vehicle is considered to be detected and vd is set to 1, and processing continues at entry point 3.

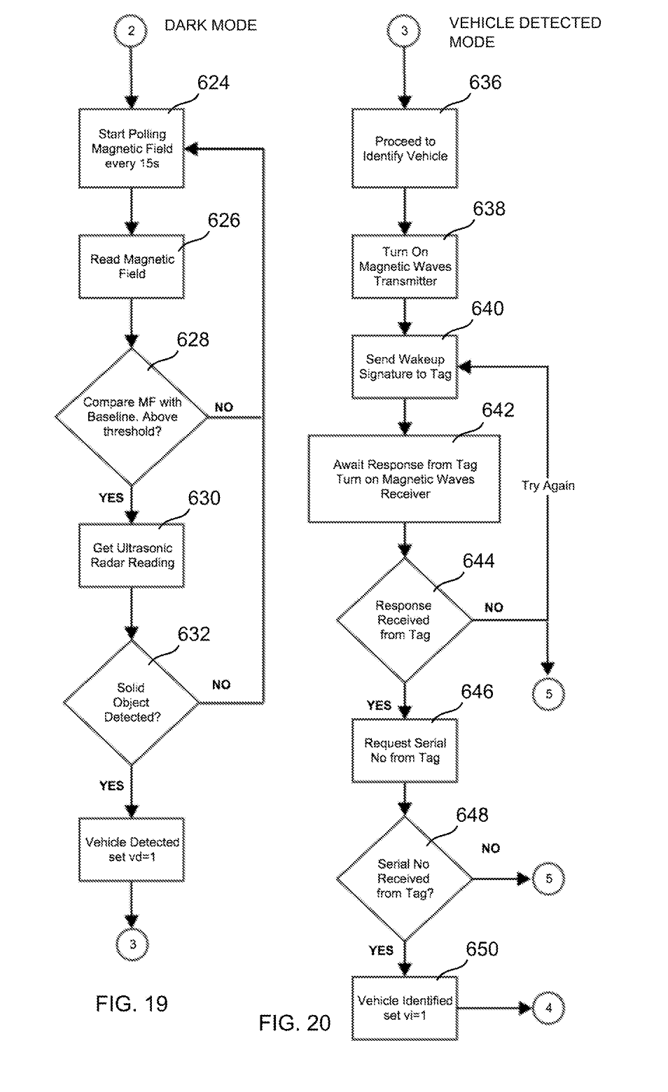

In FIG. 19, in a Dark Mode, processing begins at entry point 2, and in step 624, the magnetic sensor 242 begins polling for a change in magnetic field at intervals, in this example 15 seconds. Where a magnetic profile is sought to be obtained, this interval is substantially shorter, for example less than one hundredth of a second to several seconds. In step 626 a particular magnetic field reading is obtained. In step 628, the magnetic field reading is compared with the baseline reading of step 602. If the change in magnetic field reading is above a predetermined threshold, processing continues at step 630, otherwise polling resumes at step 624. After a predetermined time period, polling can be stopped, and processing can resume at entry point 1. In step 630, an acoustic reading is obtain from acoustic sensor 244, and the reading is analyzed by processor 204 to determine, in step 632, if a solid object, and more particularly a vehicle, is indicated to be present within space 404. If so, vd is set to 1, and processing continues at entry point 3.

In FIG. 20, in a Vehicle Detected Mode, a vehicle has been detected, and processing continues at step 636, where instructions are directed to identifying the parking vehicle. In step 638, a low frequency transmission is initiated by transceiver 214, and a ‘wakeup’ signal is sent to tag 102 in step 640. Processor 204 waits a predetermined time interval in step 644, and if the interval is met without a response from tag 102, processing either continues at entry point 5, or as programmed, a wakeup signal can be reset a predetermined number of times, in which processing is resumed at step 640. In step 646, a response has been received from tag 102, after which a request is made by base 200 to tag 102, using LF communication by transceiver 214, for a serial number of tag 102. If a serial number is received in step 648, then the vehicle identified mode is set as vi=1 in step 650 and processing continues at entry point 4; otherwise, processing continues at entry point 5.

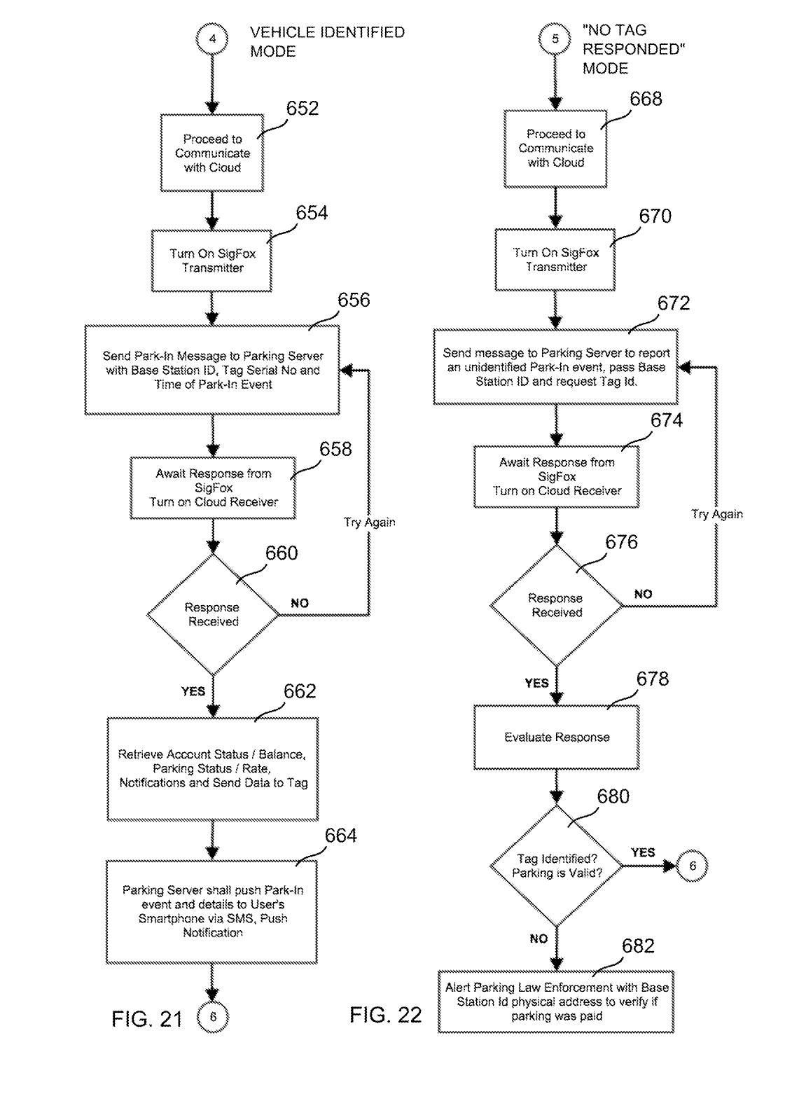

In FIG. 21, in a Vehicle Identified Mode, processing begins at entry point 4, wherein at step 652, base 200 begins instructions for communicating with the cloud, or one or more servers 320 connected to the internet. In step 654, a SigFox device 266 or other longer-range transceiver relative to transceiver 214 is activated, and in step 656 a park-in message is sent to another SigFox device 266 and ultimately through relays to a WAN such as the internet and to parking server 320, which message corresponds to a new parking event. The message can include the base station ID, the tag serial number, and the time the parking event began. In step 658, the SigFox device 266 awaits a response from server 320. In step 660, if no response is received, processing can be restarted a predetermined number of times at step 656. If a response is received at step 662, it can include an account status and balance, a parking status, parking rate information, notifications, for example from system 100 or 500, and this data is communicated by transceiver 214 to tag 102. In step 664, server 320 pushes, or sends data regarding the park-in event to a smartphone associated with tag 102, which can be carried out by SMS push notification, or any other known method, after which processing continues at entry point 6.

In FIG. 22, in a ‘No Tag Responded’ Mode, processing begins at entry point 5, and in steps 668 and 670, communication to the cloud is initiated using SigFox device 266. In step 672, a message is sent to server 320 that a parking event took place in which the vehicle was not identified. The base station 200 ID is transmitted, along with a request for the Tag ID. In the event the tag was unable to communicate with base 200, it may otherwise have received the base station ID, and can communicate that, together with its own ID, through an alternate pathway, as described herein. In step 674 a response is awaited from server 320, and if not received in step 676, an additional request can be made a predetermined number of times. In step 678, a response has been received, and is evaluated by processor 204. In step 680, if the processor has determined the tag is valid, processing continues at entry point 6; otherwise, in step 682, system 100 can alert parking law enforcement with the base station ID and physical location or address, in order to determine if parking was paid for using some other method, for example a coin meter or purchased parking slip. It is noted that system 100 can thus be used in coordination with other parking systems. Parking enforcement personnel can be equipped with a smartphone 340 or other computing device, and app 322 or a similar app, which is configured to advise if a particular vehicle is authorized using system 100.

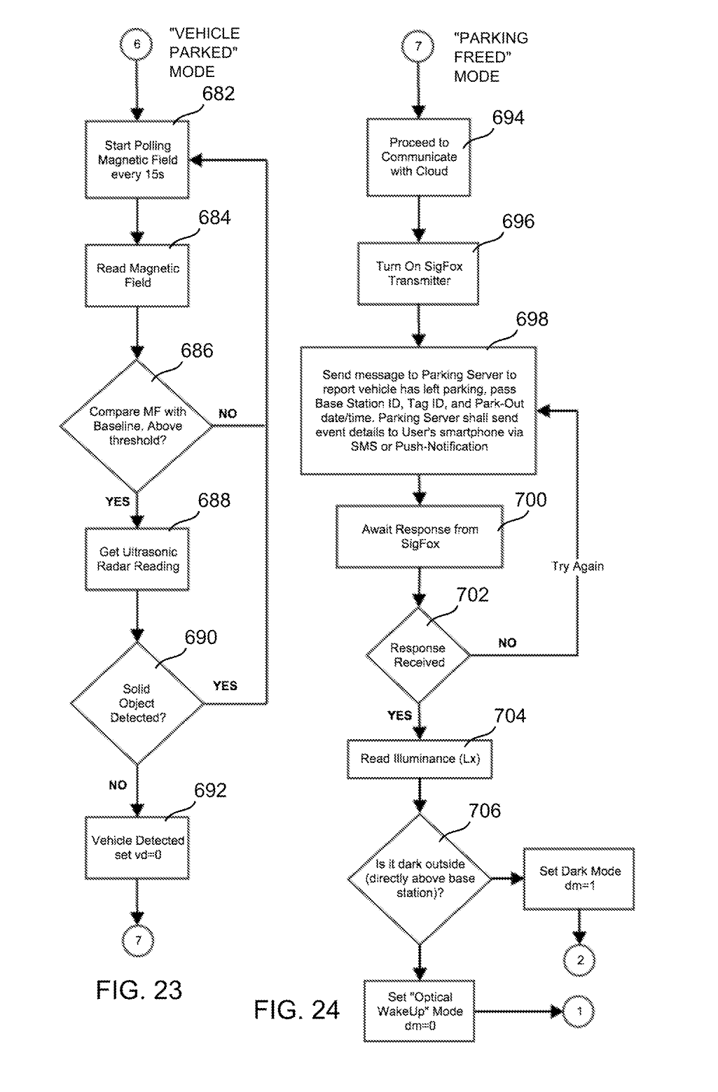

In FIG. 23, in a ‘Vehicle Parked’ Mode, it is determined if a vehicle has left parking space 404. In step 682 magnetic field sensor 242 polls the magnetic field in the area of parking space 404 at predetermined intervals. A reading at step 684 is compared at step 686 with a baseline reading, and if above a threshold, additional readings are taken at step 682. If magnetic sensor readings are below the threshold, ultrasonic readings are taken by acoustic sensor 244 at step 688 to confirm absence of the vehicle. In step 690, if readings indicate a solid object or vehicle is no longer detected, the vehicle detected flag is set to 0 in step 692, and processing continues at entry point 7; otherwise, processing resumes at step 682, and additional magnetic readings are taken.

In FIG. 24, in a ‘Parking Freed’ Mode, processing begins at entry point 7, wherein at step 694, base 200 begins instructions for communicating with the cloud. In step 696, a SigFox device 266 is activated, and in step 696 a Park-Out message is sent, which message corresponds to the vehicle having left, and the current parking session ending. A message is further sent to a smartphone 340 associated with tag 102, with information pertaining to the Park-Out event. In step 700 and 702, a response is awaited from server 320, and if not received, processing continues at step 698 a predetermined number of times; otherwise, if server 320 replies that the park-out message was received, optical sensor 254 obtains a new light level reading in step 704, which is analyzed in step 706 to determine if the light level corresponds to darkness directly above base station 200. If dark, dark mode is set to 1, and processing resumes at entry point 2; otherwise, optical ‘wakeup’ mode is set, dark mode is set to 0, and processing resumes at entry point 1.

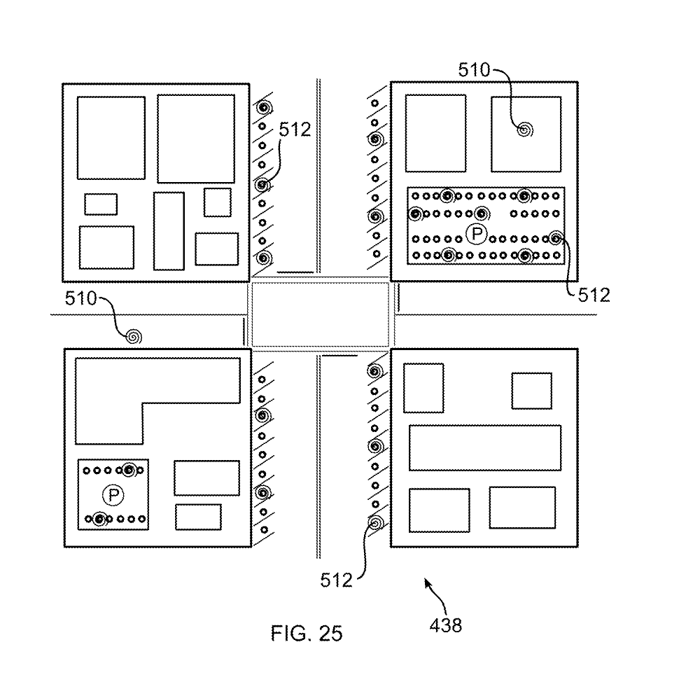

With reference to FIG. 25, in an embodiment of the disclosure, one or more of base stations 200, relays 300, and tags 102 participate as beacon sites 510 in a notification beacon system 500. More particularly, any of base station 200, relay 300, or tag 102 which includes a Bluetooth transceiver can present relevant information to a Bluetooth enabled personal computing device, such as a smartphone 340. It should be understood that, as the date of this writing, Bluetooth is particularly adapted to the beacon system 200 described herein, however other data transmission forms may become popular and which one skilled in the art will recognize can provide the same functionality as Bluetooth. Accordingly, such other data transmission form can be substituted with Bluetooth herein.

In one embodiment, any of Bluetooth enabled base station 200, relay 300, or tag 102, hereinafter parking beacon 512, or collectively with all parking beacons of beacon system 500, beacon 510. As illustrated in FIG. 25, only selected base stations 200, relays 300, or tags 102 can be provided with Bluetooth communication, or if all are provided with it, only selected locations need to participate in beacon system 500, in order to have sufficient distribution of beacons 510. Parking beacons 512, being connected to system 100 as described herein, have access to or have stored information pertaining to a location of tag 102, which tag may be associated with one or more driver and accordingly the driver's smartphone 340. If the driver grants permission and allows Bluetooth pairing with Bluetooth devices of beacon system 500, an application executing upon the driver's smartphone will pair with the nearest beacon 510. Thus, upon parking, a parking beacon 512 initiates notifications to smartphone 340, as system 100 is aware that a user of system 100/500 has arrived at a particular new destination.

Notifications can have many different purposes, including providing information relating to any of safety, walking routes, shopping, social interactions, tourism, and disturbance to a vehicle associated with tag 102, for example. Successive beacons 510 can continue to pair with smartphone 340 before previous beacons 510 begin to fall out of range. Range failure can be detected due to improper communication, or a distance from the current beacon, as provided by GPS data within the smartphone. Where system 100 is provided for on-street parking in a city, there may be sufficient distribution of parking beacons 512 to map or provide coverage for most of the relevant areas of the city, and particularly shopping, office, and industrial areas where parking is dense. However, individual shops, offices, restaurants, event venues, and other locations may provide their own beacons 510 which participate in beacon system 500.

It may be possible to know a location of smartphone 340 with limited accuracy whether or not the smartphone provides GPS data to beacon system 500. More particularly, each beacon 510 can be provided with its own GPS coordinate, and therefore a location of a smartphone 340 that is connected to beacon system 500 can be known based upon a location of the current connected beacon 510. A location of a previously connected beacon, as well as other gathered data, can further refine a probable current location of smartphone 340, and thus a particular person.

A beacon application or beacon app 522 executing within smartphone 340 can perform calculations pertaining to a location of smartphone 340, and can obtain information relevant to the current location from the current beacon 510, or from a cellular or wireless network to which the smartphone is connected. In an embodiment, an offer or reward can be made from a vendor that is nearby smartphone 340. That offer can include, for example, free parking associated with the current parking space 404, if the person associated with smartphone 340 makes a purchase at the vendor location. In this embodiment, beacon system 500 communicates with system 100 to adjust any fees associated with the current parking instance.

It should be understood that beacon system 500 can form an integral part of system 100 of the disclosure, and can be implemented upon server 320. Alternatively, beacon system 500 can be separate from system 100, and can participate together with parking beacons 512, or can use separate beacons 510 and servers. If a separate system, beacon 510 can comprise any Bluetooth enabled device having a processor, for example a desktop computer, embedded system, or a portable computing device.

In a further embodiment, system 100 and/or system 500 can provide useful and valuable information pertaining to vehicles and drivers parking within system 100, or participating in a beacon system 500. To protect privacy, only agreed to information pertaining to participants can be disclosed, pursuant to a privacy policy. Information which is not deemed private, particularly if it cannot be connected with an individual or company, can help cities and communities plan growth, development, and public safety, and can help current and prospective retail businesses better serve the community and their customers. There are numerous other possible beneficial uses for information pertaining to parked vehicles, and the movement of people in a community, whether associated with a parked vehicle or not. In a further embodiment, any data to be provided for purposes other than regular billing and management of parking aspects of system 100 can first be stripped of all personal information, or information vulnerable to identify theft.

In a further example, vehicles associated with tag 102 can make purchases without presenting payment information. For example, at a gasoline filling station, the presence of tag 102 can indicate to a base station 200 at the filling station that the vehicle is present in a parking space 404 in front of a particular pump. The pump can then be activated to dispense the appropriate fuel for the vehicle. The transaction can be automatically concluded after the vehicle containing tag 102 drives away, thereby shutting off services at that pump location.

A similar service can be provided at any drive-through location. Where communication must be established while vehicle 400 is still in motion, base 200 can be provided with an elongate LF communication antenna. System 100/500 can further be used to locate a driver's vehicle if the current parking space 404 is forgotten, is not known, or the vehicle has been moved without authorization.

Smartphone app 322 can be combined with some or all of the features of app 522, or they can be provided separately within smartphone 340, or can be provided as a plurality of separate modules.

The disclosure provides a parking meter system which can provide for a predetermined time interval during which a permitted vehicle may be removed from the parking space, without requiring a new payment transaction. For example, once a parking patron has paid for a parking space for a period of time, a system of the disclosure can allow the vehicle to be moved out of range of the original parking space, and later repositioned within the same space or another space controlled by the system, without incurring an additional charge if within the original time period. This can facilitate, for example, a short errand by the parking patron, which reduces wasted time and the costs of additional financial transactions. A maximum interval during which the vehicle is not within the parking system can be predetermined, such that a final billing transaction can take place.

System 100 can form part of a greater Internet of Things (IoT), contributing information useful for relating to other connected devices. For example, system 100 can alert other systems when a substantial number of vehicles are leaving their respective parking spaces 404 and entering the roadways, or vice versa. Such other systems could be draw bridges, traffic and pedestrian crosswalk signals, ferries, trains, tolls, and traffic news or law enforcement systems.

System 100 of the disclosure provides a parking system that enables users to quickly park and be on their way, and also provides a parking owner or manager to have more complete control of a parking operation, while obtaining valuable real-time information which can promote maximum efficiency and revenue, while minimizing downtime or idle spaces. With information provided by system 100, for example, a parking manager has the ability to raise or lower prices in real-time for specific spaces and areas based on demand or other factors, without the need to have a technician alter a physical tolling or metering machine. The instant disclosure can enable such changes to be made using a computing device and a communication network such as the Internet.

The disclosure enables the collection of useful data, such as time and occupancy, and further to analyze the collected data, which can be provided to a parking manager by a communication network. Servers 320, or any other processor of system 100 can process data collected for a single parking site, or a plurality of parking sites, and can be configured to analyze this data and provide suggestions and options for the parking manager in order to improve revenue and the performance of a parking facility. For example, a pop-up notification to a computing device 340 of the parking manager can suggest, for example “If you raise the rate of the following spaces by $0.50 per hour, your yearly revenue will increase by 7%. Would you like for me to make this change?” Server 320 can then make the change, or a modified change, if requested to do so by the parking manager. A variety of software algorithms can be employed to carry out the foregoing logic, and other logic problems, as known in the art, including the use of artificial intelligence or genetic algorithm techniques.

The disclosure provides a system and method for a virtual parking meter that can communicate by transmitting and receiving using a base station 200 from the ground level or below ground level, upwards through water, snow, or ice, and through the frame or chassis of a vehicle 400, to a tag 102 placed inside the vehicle. The disclosure additionally provides for identifying the car or vehicle operator through association with the tag 102 within the vehicle, or through data provided during a parking transaction. A variety of transmission protocols are described, including an LF protocol, that enables communication between a buried device 200 and a tag 102 inside the vehicle 400. A low-frequency transceiver base station 200 and an associated tag 102 each can consume very little energy, and use magnetic waves to overcome back-scatter and other transmission issues associated with higher frequencies, such as RF, which occur in environments containing metal or water, for example.

Once an ID identifying the vehicle or its operator has been retrieved from tag 102, system 100 system can communicate via the cloud, in an embodiment using an existing or custom application programming interface (API), and can post a transaction that will draw payment from a prepaid account (or post-paid such as credit card, or apple pay) associated with the ID of the tag 102.

Once a car is identifiable when located, data obtained can be used to solve related problems, including for example location-based advertising, and transportation planning.

With respect to location-based advertising, vehicle operators can benefit from opportunities provided by local facilities, for example to buy a product such as a cup of coffee, and receive a period of time, for example 15 minutes, of free parking. Other incentives may be price reductions or free products, to encourage vehicle operators to utilize local businesses. Additionally, a consumer of data provided by system 100 can generate advertisements sent to the vehicle operator's cellphone, for example using a mobile app of system 100, when vehicle 400 is parked at a specific location. System 100 can provide additional information important to reaching and benefiting consumers and facility operators, including statistics of parking usage by customer type, car types, and other factors, and monitoring of specific spaces in order to provide notifications to a vehicle operators when such spaces are empty.

System 100 can improve transportation planning by providing data to municipalities or private parking facility operators to better manage traffic, to generate heat maps showing zones of high utilization, and to optimize prices or provide customized prices based on customer profiles, fleet composition, or marketplace competition. With respect to the latter, system 100 can enable bidding for specific parking spaces, where consumers having the greatest need can obtain parking, and parking facility operators can maximize revenue. Bidding can be carried out using existing online resources, or can be managed by system 100, including one or more applications executing upon computing device 340, in communication with servers 320.

The device and methods of the disclosure provide a more efficient parking payment system that provides a user a more positive experience, while reducing frustration and loss of time and money.

### Example Computing System

FIG. 4 illustrates the system architecture for a computer system 1000, such as a process controller, or other processor on which or with which the disclosure may be implemented. The exemplary computer system of FIG. 4 is for descriptive purposes only. Although the description may refer to terms commonly used in describing particular computer systems, the description and concepts equally apply to other systems, including systems having architectures dissimilar to FIG. 10. One or more sensors, not shown, provide input to computer system 1000, which executes software stored on non-volatile memory, the software configured to receive inputs from sensors or from human interface devices, in calculations for controlling system 200. Software can be of any known type, including for example C, C++, BASIC, Java, Javascript, Assembler, or any software language currently known or hereinafter developed.

Computer system 1000 includes at least one central processing unit (CPU) 1105, or server, which may be implemented with a conventional microprocessor, ASIC, or microcontroller, for example, and a random access memory (RAM) 1110 for temporary storage of information, and a read only memory (ROM) 1115 for permanent storage of information. A memory controller 1200 is provided for controlling RAM 1110.

A bus 1130 interconnects the components of computer system 1000. A bus controller 1125 is provided for controlling bus 1130. An interrupt controller 1135 is used for receiving and processing various interrupt signals from the system components.

Mass storage may be provided by DVD ROM 1147, or flash or rotating hard disk drive 1152, for example. Data and software, including software 400 of the disclosure, may be exchanged with computer system 1000 via removable media such as diskette, CD ROM, DVD, Blu Ray, or other optical media 1147 connectable to an Optical Media Drive 1146 and Controller 1145. Alternatively, other media, including for example a media stick, for example a solid state USB drive, may be connected to an External Device Interface 1141, and Controller 1140. Additionally, a device 100 in accordance with the disclosure may be connected to computer system 1000 through External Device Interface 1141, for example by a USB connector, BLUETOOTH connector, Infrared, or WiFi connector, although other modes of connection are known or may be hereinafter developed. Storage can be carried out by any known or hereinafter developed type, including MEMS, nanotechnological storage devices, and mechanical or solid state hard drive. A hard drive 1152, for example, can be part of a fixed disk drive 1151 which is connected to bus 1130 by controller 1150. It should be understood that other storage, peripheral, and computer processing means may be developed in the future, which may advantageously be used with the disclosure.

User input to computer system 1000 may be provided by a number of devices. For example, a keyboard 1156 and mouse 1157 are connected to bus 1130 by controller 1155. An audio transducer 1196, which may act as both a microphone and a speaker, is connected to bus 1130 by audio controller 1197, as illustrated. It will be obvious to those reasonably skilled in the art that other input devices, such as a pen and/or tablet, Personal Digital Assistant (PDA), mobile/cellular phone and other devices, may be connected to bus 1130 and an appropriate controller and software, as required. DMA controller 1160 is provided for performing direct memory access to RAM 1110. A visual display is generated by video controller 1165 which controls video display 1170. Computer system 1000 also includes a communications adapter 1190 which allows the system to be interconnected to a local area network (LAN) or a wide area network (WAN), schematically illustrated by bus 1191 and network 1195.

Operation of computer system 1000 is generally controlled and coordinated by operating system software, such as a Windows system, commercially available from Microsoft Corp., Redmond, Wash., or LINUX, or an embedded operating system. The operating system controls allocation of system resources and performs tasks such as processing scheduling, memory management, networking, and I/O services, among other things. In particular, an operating system resident in system memory and running on CPU 1105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

### Example Transmitting Computing System

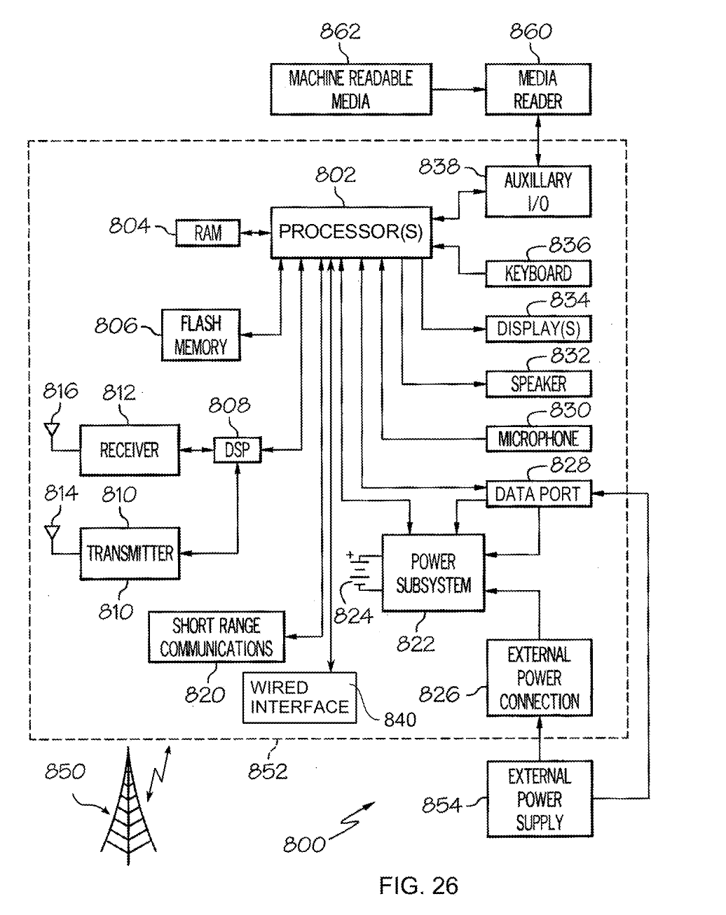

FIG. 26, is a block diagram of an electronic device and associated components 800, which can be used in carrying out the disclosure. In this example, an electronic device 852 is a wireless two-way communication device with voice and data communication capabilities. Such electronic devices communicate with a wireless voice or data network 850 using a suitable wireless communications protocol. Wireless voice communications are performed using either an analog or digital wireless communication channel. Data communications allow the electronic device 852 to communicate with other computer systems via the Internet. Examples of electronic devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated electronic device 852 is an example electronic device that includes two-way wireless communications functions. Such electronic devices incorporate communication subsystem elements such as a wireless transmitter 810, a wireless receiver 812, and associated components such as one or more antenna elements 814 and 816. A digital signal processor (DSP) 808 performs processing to extract data from received wireless signals and to generate signals to be transmitted. The particular design of the communication subsystem is dependent upon the communication network and associated wireless communications protocols with which the device is intended to operate.

The electronic device 852 includes a microprocessor 802 that controls the overall operation of the electronic device 852. The microprocessor 802 interacts with the above described communications subsystem elements and also interacts with other device subsystems such as flash memory 806, random access memory (RAM) 804, auxiliary input/output (I/O) device 838, data port 828, display 834, keyboard 836, speaker 832, microphone 830, a short-range communications subsystem 820, a power subsystem 822, and any other device subsystems.

A battery 824 is connected to a power subsystem 822 to provide power to the circuits of the electronic device 852. The power subsystem 822 includes power distribution circuitry for providing power to the electronic device 852 and also contains battery charging circuitry to manage recharging the battery 824. The power subsystem 822 includes a battery monitoring circuit that is operable to provide a status of one or more battery status indicators, such as remaining capacity, temperature, voltage, electrical current consumption, and the like, to various components of the electronic device 852.

The data port 828 of one example is a receptacle connector 104 or a connector that to which an electrical and optical data communications circuit connector 800 engages and mates, as described above. The data port 828 is able to support data communications between the electronic device 852 and other devices through various modes of data communications, such as high speed data transfers over an optical communications circuits or over electrical data communications circuits such as a USB connection incorporated into the data port 828 of some examples. Data port 828 is able to support communications with, for example, an external computer or other device.

Data communication through data port 828 enables a user to set preferences through the external device or through a software application and extends the capabilities of the device by enabling information or software exchange through direct connections between the electronic device 852 and external data sources rather then via a wireless data communication network. In addition to data communication, the data port 828 provides power to the power subsystem 822 to charge the battery 824 or to supply power to the electronic circuits, such as microprocessor 802, of the electronic device 852.

Operating system software used by the microprocessor 802 is stored in flash memory 806. Further examples are able to use a battery backed-up RAM or other non-volatile storage data elements to store operating systems, other executable programs, or both. The operating system software, device application software, or parts thereof, are able to be temporarily loaded into volatile data storage such as RAM 804. Data received via wireless communication signals or through wired communications are also able to be stored to RAM 804.

The microprocessor 802, in addition to its operating system functions, is able to execute software applications on the electronic device 852. A predetermined set of applications that control basic device operations, including at least data and voice communication applications, is able to be installed on the electronic device 852 during manufacture. Examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the electronic device 852 through, for example, the wireless network 850, an auxiliary I/O device 838, Data port 828, short-range communications subsystem 820, or any combination of these interfaces. Such applications are then able to be installed by a user in the RAM 804 or a non-volatile store for execution by the microprocessor 802.

In a data communication mode, a received signal such as a text message or web page download is processed by the communication subsystem, including wireless receiver 812 and wireless transmitter 810, and communicated data is provided the microprocessor 802, which is able to further process the received data for output to the display 834, or alternatively, to an auxiliary I/O device 838 or the Data port 828. A user of the electronic device 852 may also compose data items, such as e-mail messages, using the keyboard 836, which is able to include a complete alphanumeric keyboard or a telephone-type keypad, in conjunction with the display 834 and possibly an auxiliary I/O device 838. Such composed items are then able to be transmitted over a communication network through the communication subsystem.

For voice communications, overall operation of the electronic device 852 is substantially similar, except that received signals are generally provided to a speaker 832 and signals for transmission are generally produced by a microphone 830. Alternative voice or audio I/O subsystems, such as a voice message recording subsystem, may also be implemented on the electronic device 852. Although voice or audio signal output is generally accomplished primarily through the speaker 832, the display 834 may also be used to provide an indication of the identity of a calling party, the duration of a voice call, or other voice call related information, for example.

Depending on conditions or statuses of the electronic device 852, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 820 provides for data communication between the electronic device 852 and different systems or devices, which need not necessarily be similar devices. For example, the short-range communications subsystem 820 includes an infrared device and associated circuits and components or a Radio Frequency based communication module such as one supporting Bluetooth® communications, to provide for communication with similarly-enabled systems and devices, including the data file transfer communications described above.

A media reader 860 is able to be connected to an auxiliary I/O device 838 to allow, for example, loading computer readable program code of a computer program product into the electronic device 852 for storage into flash memory 806. One example of a media reader 860 is an optical drive such as a CD/DVD drive, which may be used to store data to and read data from a computer readable medium or storage product such as computer readable storage media 862. Examples of suitable computer readable storage media include optical storage media such as a CD or DVD, magnetic media, or any other suitable data storage device. Media reader 860 is alternatively able to be connected to the electronic device through the Data port 828 or computer readable program code is alternatively able to be provided to the electronic device 852 through the wireless network 850.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method for managing parking using one or more computers connected to an electronic communication network, the method comprising:
associating an electronic tag with each of a plurality of vehicles, each tag configured to at least one of receive and transmit information at a first frequency;
positioning an electronic base station proximate each of a plurality of parking spaces, each base configured to at least one of receive and transmit information at the first frequency;
using one of the tag and base station to communicate identification information to the other of the tag and base station at the first frequency;
communicating the received information, using the tag or base station which received the communicated information, to one or more servers; and
processing the communicated information by the one or more servers to determine an extent of parking usage.

2. The method of claim 1, wherein the first frequency is in the LF range.

3. The method of claim 1, wherein the tag and base station communicate using magnetic induction.

4. The method of claim 1, wherein the base station is positioned proximate a driving surface of the one or more parking spaces.

5. The method of claim 1, wherein the base station is positioned below the driving surface of the one or more parking spaces.

6. The method of claim 1, wherein an electronic base station is positioned proximate a driving surface of each of the one or more parking spaces.

7. The method of claim 6, wherein an electronic tag is positioned within a vehicle that is parked within one of the one or more parking spaces.

8. The method of claim 1, wherein communicating to one or more servers is carried out using a wide area network of receivers using a publicly available radio frequency.

9. The method of claim 1, wherein communicating to one or more servers is carried out by communicating with a local area network that is connected to the internet, the servers connected to the internet.

10. A method for managing parking using one or more computers connected to an electronic communication network, the method comprising:
associating an electronic tag with each of a plurality of vehicles, each tag configured to at least one of receive and transmit information using magnetic induction communication;
positioning an electronic base station proximate each of a plurality of parking spaces, each base station configured to at least one of receive and transmit information at the first frequency;
using one of the tag and base station to communicate identification information to the other of the tag and base station using magnetic induction communication;
communicating the received information, using the tag or base station which received the communicated information, together with identification information of the tag or base station which received the communicated information, to one or more servers; and
processing the communicated information by the one or more servers to determine an extent of parking usage.

11. The method of claim 10, wherein the base station is positioned proximate a driving surface of the parking space to be located beneath a vehicle when the vehicle is parked in the parking space.

12. The method of claim 10, wherein the base station is positioned below the driving surface of the one or more parking spaces.

13. The method of claim 10, wherein communicating to one or more servers is carried out using a wide area network of receivers using a publicly available radio frequency.

14. The method of claim 10, wherein communicating to one or more servers is carried out by communicating with a local area network that is connected to the internet, the servers connected to the internet.

15. The method of claim 10, wherein communicating to one or more servers is carried out using at least one of the SIGFOX, LoRaWAN, and WEIGHTLESS protocols.
